(19) United States
(12) Patent Application Publication
(10) Pub. No.: US 2026/0031898 A1
(43) Pub. Date: Jan. 29, 2026

(54) HYBRID POWER CONTROL ALGORITHM FOR RADIO FREQUENCY TERMINALS

(71) Applicant: Thales Avionics, Inc., Irvine, CA (US)

(72) Inventors: Eric GROBELNY, Indialantic, FL (US); Martin MATURA, Melbourne, FL (US)

(21) Appl. No.: 18/785,916

(22) Filed: Jul. 26, 2024

(51) Int. Cl. H04B 7/185

(52) U.S. Cl. CPC H04B 7/18519

(57) ABSTRACT

An aircraft satellite communication terminal includes a modem to receive data packets from an aircraft on-board network, encode the data packets, and convert the encoded data packets to intermediate frequency signaling. The terminal includes an upconverter circuit that receives the intermediate frequency signaling and upconverts to satellite carrier frequency signaling. The terminal includes a satellite antenna aperture configured to receive the satellite carrier frequency signaling and transmit the satellite carrier frequency signaling for receipt by a satellite. The terminal includes power measurement circuits configured to measure power at inputs and/or outputs of the terminal components. The terminal includes a power controller configured to control power of the intermediate frequency signaling provided through the output interface of the modem and/or to control power of the satellite carrier frequency signaling provided through the output interface of the upconverter circuit, based on the power measurements by the measurement circuits.

### TECHNICAL FIELD

The present disclosure relates to aeronautical broadband communication systems including satellite communication systems for aircraft.

### BACKGROUND

There is an increasing need for a communication system that can provide high bandwidth and reduced cost in-flight connectivity that is optimized for performance and requires less maintenance for commercial aircraft (e.g., widebody, narrowbody and regional aircraft), business jets, etc.

Maximizing the output power of a satellite communication terminal to optimize system performance presents a multifaceted challenge tied to various constraints and uncertainties inherent in the system. A goal is to achieve peak transmission capabilities while complying with stringent power restrictions imposed by the antenna subsystem and regulatory guidelines.

Controlling power of the terminal is complex due to the variability introduced during manufacturing, installation, and the inevitable aging or degradation of terminal components over time. Each of these factors can significantly impact the terminal's ability to deliver consistent output power, influencing overall system performance.

Manufacturing introduces initial variations in component quality and performance tolerances, affecting how efficiently the terminal can convert input power to output power. Installation conditions further contribute to variability, including factors like alignment precision, cabling quality, and environmental considerations such as temperature fluctuations or mechanical stress.

Moreover, the long-term degradation of components, including amplifiers, transmitters, and signal processing units, poses a continuous challenge. Aging can lead to reduced efficiency, increased signal noise, or outright failure, necessitating ongoing monitoring and maintenance to sustain optimal performance.

### SUMMARY

Various embodiments of the present disclosure are directed to an aircraft satellite communication terminal. The terminal includes a modem configured to receive data packets from an aircraft on-board network, encode the data packets, and convert the encoded data packets to intermediate frequency signaling provided to an output interface. The terminal further includes an upconverter circuit that receives through an input interface the intermediate frequency signaling and upconverts to satellite carrier frequency signaling provided to an output interface. The terminal further includes a satellite antenna aperture configured to receive the satellite carrier frequency signaling through an input interface and transmit the satellite carrier frequency signaling for receipt by a satellite. The terminal further includes at least two power measurement circuits configured to measure power of at least two different ones of: the intermediate frequency signaling provided to the output interface of the modem; the intermediate frequency signaling received through the input interface of the upconverter circuit; the satellite carrier frequency signaling provided through the output interface of the upconverter circuit; the satellite carrier frequency signaling received through an input interface of the satellite antenna aperture; and the satellite carrier frequency signaling transmitted by the satellite antenna aperture. The terminal further includes a power controller configured to control power of the intermediate frequency signaling provided through the output interface of the modem and/or to control power of the satellite carrier frequency signaling provided through the output interface of the upconverter circuit, based on the power measurements by the at least two power measurement circuits.

Other aircraft satellite communication terminals according to embodiments of the present disclosure will be or become apparent to one with skill in the art upon review of the following drawings and detailed description. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates the transmit chain and the locations of potential power detectors in an aircraft satellite communication terminal in accordance with various embodiments of the present disclosure;

FIG. 2 illustrates a component block diagram of an aircraft communication system, satellites, and ground communication system which are configured to operate in accordance with various embodiments of the present disclosure;

FIG. 3 illustrates some components of a broadband aircraft satellite communication terminal which can be configured in accordance with various embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present or used in another embodiment.

As explained above, optimizing communication system performance presents a multifaceted challenge tied to various constraints and uncertainties inherent in the system. One goal is to achieve peak transmission capabilities while complying with stringent power restrictions imposed by the antenna subsystem and regulatory guidelines. How the transmit pathway is designed and tuned is important because the transmitting terminal has limited transmit power and is also heavily regulated in order to reduce or eliminate potential interference with other RF devices. Within the transmitting terminal itself, the transmit path losses and/or gains must be properly understood with the goal of outputting the proper amount of power that optimizes performance while not violating regulatory restrictions. Various embodiments enhance the ability of the terminal to satisfy this goal.

Various embodiments of the present disclosure are directed to components of an aircraft satellite communication terminal which includes a modem, upconverter circuit, satellite antenna aperture, and a power controller. In accordance with present embodiment, the terminal includes power measurement circuits which can precisely estimate and/or measure power at inputs and/or outputs of various of components of the terminal.

In the terminal, the upconverter circuit may be a block upconverter (BUC) which provides various operational functions explained below:

Frequency upconversion: The primary function of the upconverter circuit (e.g., BUC) is to convert a lower frequency signal from the modem to a higher frequency suitable for transmission through the antenna. The modem can output signals at intermediate frequencies (IF). The upconverter circuit translates this signal to the higher frequencies used for transmission via the antenna, such as Ku-band or Ka-band frequencies.

Power amplification: The upconverter circuit also performs power amplification stages. This is necessary because the signal from the modem is usually weak and needs to be boosted to levels suitable for transmission over long distances to the satellite. The upconverter circuit amplifies the signal to achieve the required power levels.

Frequency stability and quality: The upconverter circuit operates to ensure that the upconverted signal is stable in frequency and meets the necessary quality standards. This is important for maintaining reliable communication links and minimizing interference.

Integration with modem and antenna: By sitting between the modem and the antenna aperture (the point where the signal is radiated into space), the upconverter circuit effectively bridges the gap between the signal processing and transmission stages. The upconverter circuit operates to ensure that the signal prepared by the modem is correctly formatted and amplified for transmission through the antenna.

Control and monitoring: The upconverter circuit is configured with interfaces for control and monitoring. This allows a power controller and/or operators to adjust transmission parameters such as frequency, power output, and other operational settings remotely.

In summary, the upconverter circuit performs a vital role in converting, amplifying, and preparing the signal from the modem for transmission through the antenna, ensuring efficient and reliable communication in satellite and other RF systems.

To address complexities of a satellite communication terminal and maximize output power effectively, multiple factors are addressed.

The first factor is calibration and tuning of the satellite communication terminal. Here, calibration processes during manufacturing and periodic recalibration throughout a satellite communication terminal's lifecycle are performed by operators and/or a power controller. This ensures that the terminal operates at peak efficiency within specified power constraints. However, when performed by a human operator, the calibration process can require the satellite communication terminal to be worked on by highly trained technicians and which holds-up the vehicle's use while recalibration is being performed.

The second factor is monitoring and maintenance of the satellite communication terminal. Implementing robust monitoring systems to track the terminal's performance metrics over time helps identify degradation trends early. Proactive maintenance schedules can mitigate potential performance dips caused by aging components.

The third factor is adaptive control algorithms in satellite communication terminals. Here, implementing adaptive control algorithms within the terminal's firmware or software can optimize power output dynamically. These algorithms adjust parameters based on real-time operating conditions, compensating for variations due to manufacturing, installation, or aging.

The fourth factor is compliance with regulations of satellite communication terminals. Adhering to regulatory guidelines ensures legal compliance and avoids interference with other communication systems. This involves strict adherence to allocated frequency bands, power limits, and emission standards set by regulatory bodies.

The fifth factor is system integration and testing of satellite communication systems. Thorough integration testing, both during initial setup and after any modifications or upgrades, is essential. This ensures that all subsystems work harmoniously together and meet performance expectations under varied operational scenarios.

In essence, maximizing the output power of a satellite communication terminal while navigating the complexities of manufacturing variabilities, installation factors, and component aging demands a comprehensive approach. By integrating meticulous calibration, adaptive control strategies, proactive maintenance, and stringent regulatory compliance, the terminal can be calibrated to operate to achieve optimal system performance while extending the operational lifespan of their satellite communication terminals.

Various embodiments of the present disclosure can be applied to optimize system performance which can include maximizing the modem output power while adhering to the power restrictions applied by limitations of the antenna subsystem and regulatory restrictions. Some embodiments operate to detect and compensate for the variabilities that come from manufacturing, installation, and aging/degradation.

Previous or traditional solutions to aging and degradation of satellite communication terminals have used static methods. Such static methods do not consider variability across parts which can lead to overdriving the antenna subsystem, violating regulatory restrictions and/or suboptimal performance. Variability also is encountered as the satellite communication terminal ages and degrades, thus further reducing the effectiveness of the static approach.

Various embodiments of the present disclosure are directed to uses of both static and dynamic approaches to control the output power of the satellite communication terminal. The static approach is used when the dynamic method produces inaccurate or undependable data. The dynamic approach may adjusts the power outputted by the modem in real time, and further can use power measurements to adjust the static approach so that aging and degradation effects of components of the terminal can be compensated for.

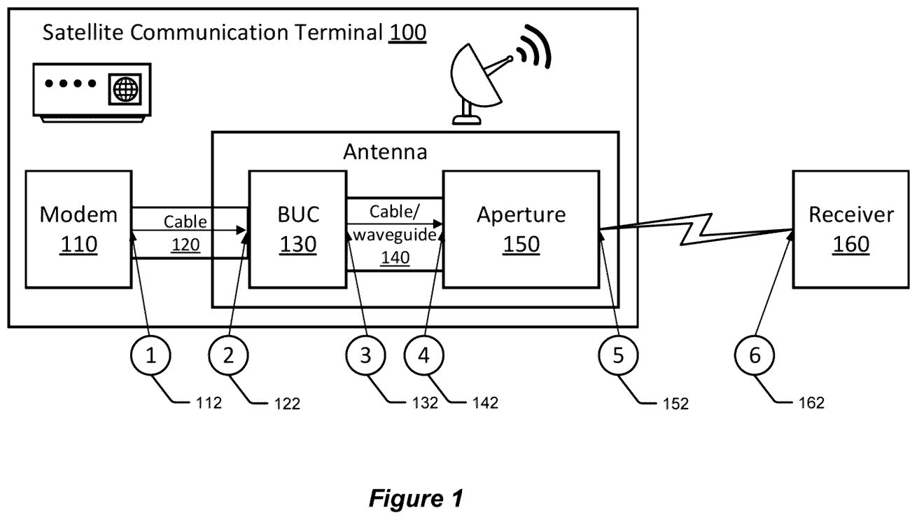

FIG. 1 illustrates the transmit chain and the locations of potential power detectors in a satellite communication terminal 100 in accordance with various embodiments of the present disclosure.

FIG. 1 shows a modem output power detector 112, BUC input power detector 122, BUC output power detector 132, aperture input power detector 142, aperture output power detector 152, receiver input power detector 162.

RF power control is used for automatic gain control (AGC) and automatic level control (ALC) to maintain suitable output levels. The RF power control uses feedback from the power detectors to control the transmitted power efficiently. In one embodiment, a power detector uses a diode-based detector circuit. The diode detection rectifies the AC signal through a unidirectional transfer characteristic diode and then transfers the rectified signal through an integrator to obtain a DC component indicating measured power. The diode detection has minimal perturbation on the signal it is measuring thus allowing measurements to be taken while the terminal is operational (i.e., transmitting user traffic).

Using a diode-based power detector, it is possible to determine the gain/loss characteristics for the various transmit chain components of the terminal. For example, comparing measurements by the modem output power detector 112 and measurements by the BUC input power detector 122, the loss of the cable 120 between the modem 110 and BUC 130 can be calculated. In another example, using the input power detector 142 measuring at the input of the aperture 150 and the output power detector 132 measuring at the output of the BUC 130, the loss of the cable or waveguide 140 between the BUC 130 and aperture 150 can be calculated. Below is a list of components/paths and the formulas that are used to measure the associated gain/loss.

The transmit power between the modem 110 and the aperture 150 should be precisely controlled in order to maximize performance while staying within regulatory restrictions. However, variability within the transmit chain introduced due to component manufacturing, installation and aging, for example, creates unique gain/loss characteristics for each system. Due to such variations and the need for precise power control, standard static methods prove to be inefficient at best.

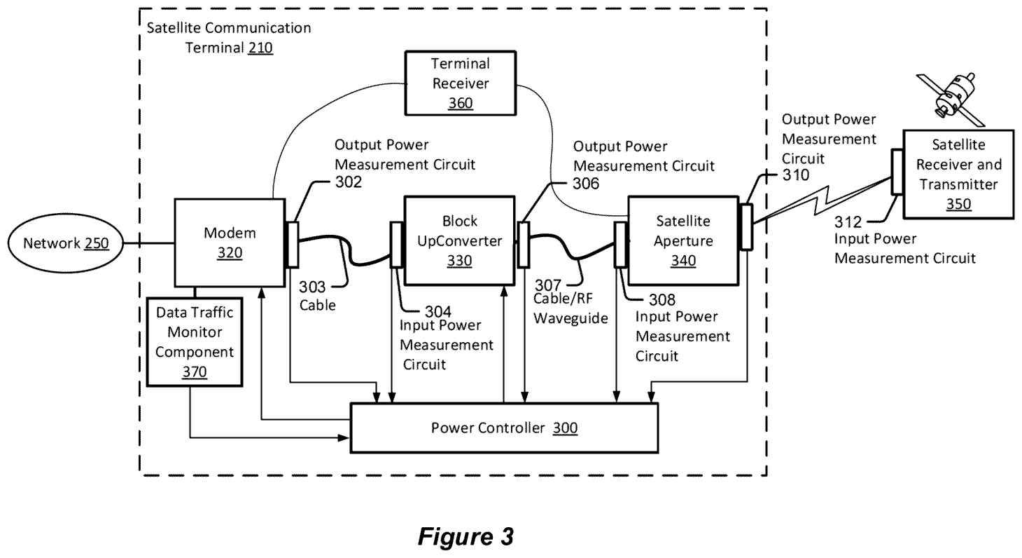

Some current solutions use a protocol called OpenBMIP in order to calibrate the modem based on the gain/loss characteristics downstream in the transmit chain. This protocol is typically used one time after the initial installation. Although it is possible for the calibration processing using OpenBMIP to be used for periodic maintenance, such an effort can be very costly due to aircraft grounding and manual touching of the aircraft. Various embodiments of the present disclosure require no on-wing support once the initial installation has been completed. Instead a power controller 300 (FIG. 3) operates to repetitively (e.g., continuously) perform adjustment of the terminal components.

| Gain/loss components/paths | Gain/loss formula |
|---|---|
| Cable loss from modem to BUC | BUC input detector - Modem output detector |
| Gain of BUC | BUC output detector - BUC input detector |
| Cable/waveguide loss from BUC to aperture | Aperture input detector - BUC output detector |
| Gain of aperture | Aperture output detector - Aperture input detector |
| Radome and transmission loss from | Receiver input detector - Aperture output detector |
| aperture to receiver | |

It is noted that if detectors are not available at certain locations along the transmit pathway, the gain/loss of the components above may be combined. Such an operation may obfuscate some changes in the terminal, but still provide important information regarding the component of the transmit chain being controlled.

One reason the transmit chain's losses and gains are important is because they can vary based on installation and also have the potential to degrade over time. Similarly, the gain/loss of the components can vary due to manufacturing/production variances. Various embodiments of the present disclosure use power measurements by the power detectors to repetitively measure the actual losses/gains within the terminal transmit pathway and use those measurements to make adjustments to more optimally tune operation of the components. This tuning results in a more optimal performing satellite communication terminal which can more strictly adhere to regulatory restrictions.

More generally, various embodiments of the present disclosure are directed to an aircraft satellite communication terminal. The aircraft satellite communication terminal includes a modem configured to receive data packets from an aircraft on-board network, encode the data packets, and convert the encoded data packets to intermediate frequency signaling provided to an output interface. The aircraft satellite communication terminal includes an upconverter circuit that receives through an input interface the intermediate frequency signaling and upconverts to satellite carrier frequency signaling provided to an output interface. The aircraft satellite communication terminal includes a satellite antenna aperture configured to receive the satellite carrier frequency signaling through an input interface and transmit the satellite carrier frequency signaling for receipt by a satellite. The aircraft satellite communication terminal includes at least two power measurement circuits configured to measure power of at least two different ones of: the intermediate frequency signaling provided to the output interface of the modem; the intermediate frequency signaling received through the input interface of the upconverter circuit; the satellite carrier frequency signaling provided through the output interface of the upconverter circuit; the satellite carrier frequency signaling received through an input interface of the satellite antenna aperture; and the satellite carrier frequency signaling transmitted by the satellite antenna aperture. The aircraft satellite communication terminal includes a power controller (e.g., power converter 300 in FIG. 3) configured to control power of the intermediate frequency signaling provided through the output interface of the modem and/or to control power of the satellite carrier frequency signaling provided through the output interface of the upconverter circuit, based on the power measurements by the at least two power measurement circuits.

In some embodiments, the power controller is configured to determine the gain and/or loss characteristics through at least part of a transmit pathway comprising the modem, the upconverter circuit, and the satellite antenna aperture, based on the power measurements by the at least two power measurement circuits. The power controller is also configured to control power of the intermediate frequency signaling provided through the output interface of the modem and/or control power of the satellite carrier frequency signaling provided through the output interface of the upconverter circuit, based on the determined gain and/or loss characteristics.

In some embodiments, the power controller responds to power measurements relating a first stage between the modem and the upconverter circuit (e.g., BUC 130). The power controller is configured to determine a first signal loss characteristic of a first cable conducting the intermediate frequency signaling from output interface of the modem to the input interface of the upconverter circuit, based on power measurement by a first power measurement circuit of the intermediate frequency signaling provided to the output interface of the modem and based on power measurement by a second power measurement circuit of the intermediate frequency signaling received through the input interface of the upconverter circuit. The power controller is also configured to control amplitude of the intermediate frequency signaling provided through the output interface of the modem based on the first signal loss characteristic.

In some other embodiments, the power controller responds to power measurements relating a second stage between the upconverter circuit and the aperture. The power controller is configured to determine a second signal loss characteristic of a second cable and/or waveguide conducting the satellite carrier frequency signaling from the output interface of the upconverter circuit to the satellite antenna aperture, based on power measurement by a third power measurement circuit of the satellite carrier frequency signaling provided to the output interface of the upconverter circuit and based on power measurement by a fourth power measurement circuit of the satellite carrier frequency signaling provided to the satellite antenna aperture. The power controller is also configured to control amplitude of the satellite carrier frequency signaling provided through the output interface of the upconverter circuit based on the second signal loss characteristic.

In some further combined embodiments, the power controller responds to power measurements relating both the first stage between the modem and the upconverter circuit and the second stage between the upconverter circuit and the aperture. The power controller is configured to determine a first signal loss characteristic of a first cable conducting the intermediate frequency signaling from output interface of the modem to the input interface of the upconverter circuit, based on power measurement by a first power measurement circuit of the intermediate frequency signaling provided to the output interface of the modem and based on power measurement by a second power measurement circuit of the intermediate frequency signaling received through the input interface of the upconverter circuit. The power controller is also configured to determine a second signal loss characteristic of a second cable and/or waveguide conducting the satellite carrier frequency signaling from the output interface of the upconverter circuit to the satellite antenna aperture, based on power measurement by a third power measurement circuit of the satellite carrier frequency signaling provided to the output interface of the upconverter circuit and based on power measurement by a fourth power measurement circuit of the satellite carrier frequency signaling provided to the satellite antenna aperture. The power controller is also configured to control amplitude of the intermediate frequency signaling provided through the output interface of the modem based on the first signal loss characteristic. The power controller is also configured to control amplitude of the satellite carrier frequency signaling provided through the output interface of the upconverter circuit based on the second signal loss characteristic.

In some other embodiments, the power controller responds to power measurement feedback from a receiver of the satellite. The power controller is further configured to receive power measurement feedback through a communication link with a satellite, wherein the power measurement feedback indicates a power measurement of the satellite carrier frequency signaling received by a receiver of the satellite. The power controller is also configured to control amplitude of the satellite carrier frequency signaling provided through the output interface of the upconverter circuit based on the power measurement feedback.

In some further embodiments, the power controller is further configured to measure gain of the upconverter circuit based on power measurement by a second power measurement circuit of the intermediate frequency signaling received through the input interface of the upconverter circuit and based on power measurement by a third power measurement circuit of the satellite carrier frequency signaling provided to the output interface of the upconverter circuit. The power controller is also configured to control gain of at least one amplifier circuit stage of the upconverter circuit based on the measured gain.

In some further embodiments, the power controller is further configured to measure gain of the satellite antenna aperture based on power measurement by a fourth power measurement circuit of the satellite carrier frequency signaling received through the input interface of the satellite antenna aperture and based on power measurement by a fifth power measurement circuit of the satellite carrier frequency signaling transmitted by the satellite antenna aperture. The power controller is also configured to control gain of at least one amplifier circuit stage of the upconverter circuit based on the measured gain of the satellite antenna aperture.

Some further embodiments are directed to the power controller being configured to receive power measurement feedback through a communication link with a satellite, wherein the power measurement feedback indicates a power measurement of the satellite carrier frequency signaling received by a receiver of the satellite. The power controller is also configured to measure gain of the satellite antenna aperture based on power measurement by a fourth power measurement circuit of the satellite carrier frequency signaling received through the input interface of the satellite antenna aperture and based on the power measurement feedback. The power controller is also configured to control gain of at least one amplifier circuit stage of the upconverter circuit based on the measured gain of the satellite antenna aperture.

Some further embodiments which are directed to approaches to controlling power of the transmit chain are now discussed.

The modem may have full control over the power outputted on the transmit chain. As a result, it should have knowledge of the transmit chain's gain/loss characteristics in order to output adequate power to establish a reliable RF link with the receiver. This information can be captured in a static table which is utilized across the same terminal installations. Other factors considered by the modem's output power algorithm include performance and regulatory restrictions. Once the modem has established a communication link with the receiver, it may be able to switch to a closed-loop power control which uses power measurements from the receiver to regulate the terminal's Equivalent Isotropic Radiated Power (EIRP) to maximize performance while adhering to regulatory limits. However, even after the terminal switches to the closed-loop method, the static table could still be used by the power control algorithm and can have a significant impact to the performance of the terminal. If the static table is or becomes inaccurate, the terminal may not be able to establish a connection at all with the receiver. As a result, it is important for this table to be and remain accurate as the terminal's performance changes over time.

Various embodiments are now discussed which are directed to establishing and tuning how the static gain table is used for power control.

The static gain table can be established in a variety of ways. One approach is to use data sheets for the components within the transmit chain to generate the table. This approach uses typical gain/loss values for each component which do not account for potential variations introduced from manufacturing and/or installation. Another approach is to measure pieces or the entire transmit chain immediately after installation while inputting a controlled and precise carrier wave (CW) signal to establish a baseline. This option has the benefit of accounting for manufacturing and installation deviations but it is still a snapshot of the system at a particular time and typically still depends on data sheets for those parts of the transmit chain that cannot be easily measured within the integrated system (e.g., aperture gain).

Regardless of the approach used to create the static table, the table is loaded into the modem so that it can use it to establish initial transmissions as well as conduct performance and regulatory assessments of the EIRP outputted from the terminal system.

Various present embodiments directed to using dynamic power measurements are now discussed.

Some embodiments are directed to not eliminating use of a static gain table, but rather complimenting it such that the gain table is more accurate throughout the lifetime of each unique RF terminal. This is accomplished through two approaches. First, dynamic measurements are taken while the terminal is operating normally. These measurements allow the power controller to determine whether to use the static value from the gain table or utilize the measured value in its power control algorithm. Determining which value to use depends on the power detector accuracy as well as the utilization of the link. Typically, in a modulated signal environment, RMS power detectors are more accurate at higher duty cycles, so the modem should ensure the dynamic value is only used under these conditions. In order to do this, the modem can use the known duty cycle of the modulated signal it is transmitting. Furthermore, if the signal is time-division multiplexed, the modem should also ensure the transmissions are of adequate duration such that the power detector provides an accurate measurement. If the power detector's configuration is unknown, the modem can use power level thresholds to determine whether a measurement is accurate or not. These thresholds can be set using a collection of real data and/or through controlled experiments.

Second, the gain of the transmit chain is repetitively (e.g., constantly) being monitored and compared against the static table. These comparisons allow adjustments to be made to the static table either through planned maintenance actions or fully autonomously through the use of machine learning techniques. Regardless of the update approach, one goal of these adjustments is to account for any degradation to the transmit chain's components that may occur due to aging or damage.

In accordance with some embodiments, periodic updates are used to update the static table. An approach for making these updates is threshold based and compares measured values to the static table's values. When measured values are +/−0.5 dB (TBR) from the static table's corresponding value, the table is updated. Care must be taken to balance accuracy and update frequency should the approach of updating be resource intensive and/or time consuming.

Some embodiments are directed to how the gain table is adapted based on power measurements.

In a first approach of these embodiments, values in the gain table are adapted.

The power controller is configured to adapt values stored in a gain table based on the power measurements by the at least two power measurement circuits. The power controller is also configured to control power level of the intermediate frequency signaling provided to the output interface of the modem, responsive to the adapted values stored in the gain table.

The power controller may be further configured to perform the adapting of values stored in a gain table only when the values of corresponding ones of power measurements by the at least two power measurement circuits are within a threshold range of the values stored in the gain table.

In a second approach of these embodiments, values in the gain table are not changed, but instead values in an offset table are adapted which is used in combination with the gain table. This may provide a more stable approach by keeping the original values in the gain table unchanged. The values in the gain table may be created through measurements performed through a repeatable and controlled calibration process during design, manufacturing, and/or after installation of the terminal in an aircraft. Keeping the values in the gain table unchanged avoids potential corruption due to spurious or erroneous power measurements.

In these embodiments, the power controller is configured to adapt values stored in an offset table based on the power measurements by the at least two power measurement circuits. The power controller is also configured to control power level of the intermediate frequency signaling provided to the output interface of the modem, responsive to the adapted values stored in the offset table combined with values stored in a gain table.

In a third approach of these embodiments, the power controller initially uses values in the gain table but then switches to using values determined based on the power measurements when a condition is satisfied.

The power controller is configured to determine whether the power measurements by the at least two power measurement circuits satisfy a stable measurement rule. Based on when the power measurements by the at least two power measurement circuits are determined to satisfy the stable measurement rule, the power controller configured to switch from controlling power level of the intermediate frequency signaling provided to the output interface of the modem responsive to values stored in a gain table to controlling power level of the intermediate frequency signaling provided to the output interface of the modem responsive to the power measurements by the at least two power measurement circuits.

The power controller may be configured to determine whether the power measurements by the at least two power measurement circuits satisfy the stable measurement rule, based on operations to determine whether the power measurements by the at least two power measurement circuits satisfy corresponding power threshold values.

Various embodiments are directed to when measurements are used to control power.

In some embodiments, the operation by the power controller to control power of the intermediate frequency signaling provided through the output interface of the modem and/or to control power of the satellite carrier frequency signaling provided through the output interface of the upconverter circuit, based on the power measurements by the at least two power measurement circuits. The operations by the power controller includes initiating use of the power measurements by the at least two power measurement circuits to control power of the intermediate frequency signaling, based on determining that data traffic contained in presently received data packets from the aircraft on-board network will cause the upconverter circuit to generate the satellite carrier frequency signaling provided through the output interface with at least a threshold duration.

The operation by the power controller to control power of the intermediate frequency signaling provided through the output interface of the modem and/or to control power of the satellite carrier frequency signaling provided through the output interface of the upconverter circuit, based on the power measurements by the at least two power measurement circuits, may further include to cease use of the power measurements by the at least two power measurement circuits to control power of the intermediate frequency signaling, based on determining that data traffic contained in later received data packets from the aircraft on-board network will cause the upconverter circuit to generate the satellite carrier frequency signaling provided through the output interface with less than the threshold duration.

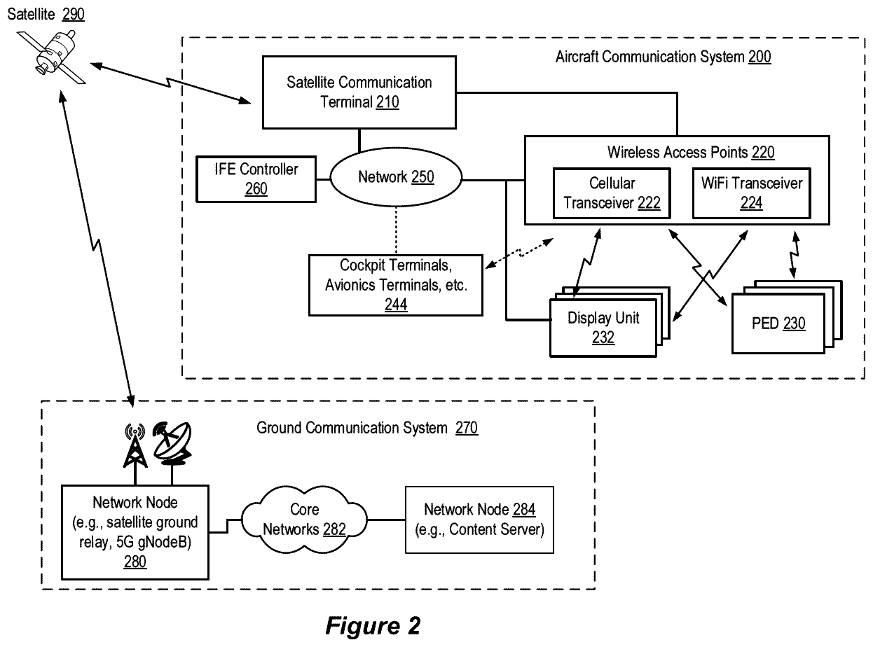

FIG. 2 illustrates a component block diagram of an aircraft communication system 200, satellite 290, and ground communication system 270 which are configured to operate in accordance with various embodiments of the present disclosure.

Referring to FIG. 2, the aircraft communication system 200 communicates with the ground communication system 270 using various communication technologies, e.g., proprietary satellite protocols, 3GPP 5G protocols, etc. More particularly, the aircraft communication system 200 includes a satellite communication terminal 210 that transmits and receives signaling through one or more satellite antennas 211 which is relayed by satellite(s) 290 to and from a radio communication network node 280 (e.g., satellite gateway, 5G gNodeB, etc.).

On the aircraft, signals received by the satellite communication terminal 210 through satellite aperture antenna(s) are transported via RF link or Common Public Radio Interface (CPRI) interface (e.g., Ethernet or fiber optic links) to wireless access points 220. The wireless access points 220 can include WiFi transceivers 222 (e.g., IEEE 802.11) or cellular transceivers 222 which may be configured to operate to retransmit data towards served terminals (e.g., PEDs 230, display units 232 (e.g., In-Flight Entertainment (IFE) seat display units), cockpit terminals 244, crew terminals 244, avionics terminals 244, etc.). Similarly, the transceivers can operate in a transport mode to receive and retransmit signals from the served terminals to the satellite communication terminal 210 for transmission toward the satellite(s) 290 for relay to the network node 280.

An IFE controller 260 can communicate with ground-based network nodes 284, e.g., content servers (e.g., movies, TV programming, games, e-books, Internet content servers, etc.), through core networks 282 and which may include private networks and public networks (e.g., Internet) and the network node 280, etc.

FIG. 3 illustrates some components of an aircraft satellite communication terminal 210 which can be configured in accordance with various embodiments of the present disclosure.

Referring to FIG. 3, a modem 320 is configured to receive data packets from an aircraft on-board network 250, encode the data packets, and convert the encoded data packets to intermediate frequency signaling provided to an output interface. An upconverter circuit 330 (e.g., BUC) receives through an input interface the intermediate frequency signaling and upconverts to satellite carrier frequency signaling provided to an output interface. A satellite antenna aperture 340 is configured to receive the satellite carrier frequency signaling through an input interface and transmit the satellite carrier frequency signaling for receipt by a satellite. A power measurement circuit 302 measures power at the output of the modem 302. Another power measurement circuit 304 measures power at the input of the upconverter circuit 330. Another power measurement circuit 307 measures power at the output of the upconverter circuit 330. Another power measurement circuit 308 measures power at the input of the aperture 340. Another power measurement circuit 310 measures power at the output of the aperture 340.

A power controller 300 is configured to control power of the intermediate frequency signaling provided through the output interface of the modem 320 and/or to control power of the satellite carrier frequency signaling provided through the output interface of the upconverter circuit 330, based on the power measurements by at least two of the power measurement circuits 302, 304, 307, and 308.

A terminal receiver 360 may receive power measurement feedback through a communication link with the satellite 350, where the power measurement feedback indicates a power measurement of the satellite carrier frequency signaling received by the receiver of the satellite 350. The satellite 350 can include an input power measurement circuit 312, e.g., which measures received signal strength. The power controller 300 can be configured to control amplitude of the satellite carrier frequency signaling provided through the output interface of the upconverter circuit 330 based on the power measurement feedback.

The terminal 210 may include a data traffic monitor component 370 which determines when data traffic input to the modem 320 from the network 250 satisfies a condition that triggers the power controller 300 to use the power measurements by the at least two power measurement circuits to control power of the intermediate frequency signaling.

In one such embodiment, the operation by the power controller 300 to control power of the intermediate frequency signaling provided through the output interface of the modem 320 and/or to control power of the satellite carrier frequency signaling provided through the output interface of the upconverter circuit 330, based on the power measurements by the at least two power measurement circuits, further includes to initiate use of the power measurements by the at least two power measurement circuits to control power of the intermediate frequency signaling, based on determining that data traffic contained in presently received data packets from the aircraft on-board network will cause the upconverter circuit 330 to generate the satellite carrier frequency signaling provided through the output interface with at least a threshold duration.

In a further embodiment, the operation by the power controller 300 to control power of the intermediate frequency signaling provided through the output interface of the modem 320 and/or to control power of the satellite carrier frequency signaling provided through the output interface of the upconverter circuit 330, based on the power measurements by the at least two power measurement circuits, further includes to cease use of the power measurements by the at least two power measurement circuits to control power of the intermediate frequency signaling, based on determining that data traffic contained in later received data packets from the aircraft on-board network will cause the upconverter circuit to generate the satellite carrier frequency signaling provided through the output interface with less than the threshold duration.

### Further Definitions and Embodiments

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

1. An aircraft satellite communication terminal comprising:
a modem configured to receive data packets from an aircraft on-board network, encode the data packets, and convert the encoded data packets to intermediate frequency signaling provided to an output interface;
an upconverter circuit that receives through an input interface the intermediate frequency signaling and upconverts to satellite carrier frequency signaling provided to an output interface;
a satellite antenna aperture configured to receive the satellite carrier frequency signaling through an input interface and transmit the satellite carrier frequency signaling for receipt by a satellite;
at least two power measurement circuits configured to measure power of at least two different ones of: the intermediate frequency signaling provided to the output interface of the modem; the intermediate frequency signaling received through the input interface of the upconverter circuit; the satellite carrier frequency signaling provided through the output interface of the upconverter circuit; the satellite carrier frequency signaling received through an input interface of the satellite antenna aperture; and the satellite carrier frequency signaling transmitted by the satellite antenna aperture; and
a power controller configured to control power of the intermediate frequency signaling provided through the output interface of the modem and/or to control power of the satellite carrier frequency signaling provided through the output interface of the upconverter circuit, based on the power measurements by the at least two power measurement circuits.

2. The aircraft satellite communication terminal of claim 1, wherein the power controller is configured to:
determine the gain and/or loss characteristics through at least part of a transmit pathway comprising the modem, the upconverter circuit, and the satellite antenna aperture, based on the power measurements by the at least two power measurement circuits; and
control power of the intermediate frequency signaling provided through the output interface of the modem and/or control power of the satellite carrier frequency signaling provided through the output interface of the upconverter circuit, based on the determined gain and/or loss characteristics.

3. The aircraft satellite communication terminal of claim 1, wherein the power controller is configured to:
determine a first signal loss characteristic of a first cable conducting the intermediate frequency signaling from output interface of the modem to the input interface of the upconverter circuit, based on power measurement by a first power measurement circuit of the intermediate frequency signaling provided to the output interface of the modem and based on power measurement by a second power measurement circuit of the intermediate frequency signaling received through the input interface of the upconverter circuit; and
control amplitude of the intermediate frequency signaling provided through the output interface of the modem based on the first signal loss characteristic.

4. The aircraft satellite communication terminal of claim 1, wherein the power controller is configured to:
determine a second signal loss characteristic of a second cable and/or waveguide conducting the satellite carrier frequency signaling from the output interface of the upconverter circuit to the satellite antenna aperture, based on power measurement by a third power measurement circuit of the satellite carrier frequency signaling provided to the output interface of the upconverter circuit and based on power measurement by a fourth power measurement circuit of the satellite carrier frequency signaling provided to the satellite antenna aperture; and
control amplitude of the satellite carrier frequency signaling provided through the output interface of the upconverter circuit based on the second signal loss characteristic.

5. The aircraft satellite communication terminal of claim 1, wherein the power controller is configured to:
determine a first signal loss characteristic of a first cable conducting the intermediate frequency signaling from output interface of the modem to the input interface of the upconverter circuit, based on power measurement by a first power measurement circuit of the intermediate frequency signaling provided to the output interface of the modem and based on power measurement by a second power measurement circuit of the intermediate frequency signaling received through the input interface of the upconverter circuit;
determine a second signal loss characteristic of a second cable and/or waveguide conducting the satellite carrier frequency signaling from the output interface of the upconverter circuit to the satellite antenna aperture, based on power measurement by a third power measurement circuit of the satellite carrier frequency signaling provided to the output interface of the upconverter circuit and based on power measurement by a fourth power measurement circuit of the satellite carrier frequency signaling provided to the satellite antenna aperture;
control amplitude of the intermediate frequency signaling provided through the output interface of the modem based on the first signal loss characteristic; and
control amplitude of the satellite carrier frequency signaling provided through the output interface of the upconverter circuit based on the second signal loss characteristic.

6. The aircraft satellite communication terminal of claim 5, wherein the power controller is further configured to:
receive power measurement feedback through a communication link with a satellite, wherein the power measurement feedback indicates a power measurement of the satellite carrier frequency signaling received by a receiver of the satellite;
control amplitude of the satellite carrier frequency signaling provided through the output interface of the upconverter circuit based on the power measurement feedback.

7. The aircraft satellite communication terminal of claim 1, wherein the power controller is configured to:
measure gain of the upconverter circuit based on power measurement by a second power measurement circuit of the intermediate frequency signaling received through the input interface of the upconverter circuit and based on power measurement by a third power measurement circuit of the satellite carrier frequency signaling provided to the output interface of the upconverter circuit; and
control gain of at least one amplifier circuit stage of the upconverter circuit based on the measured gain.

8. The aircraft satellite communication terminal of claim 7, wherein the power controller is further configured to:
measure gain of the satellite antenna aperture based on power measurement by a fourth power measurement circuit of the satellite carrier frequency signaling received through the input interface of the satellite antenna aperture and based on power measurement by a fifth power measurement circuit of the satellite carrier frequency signaling transmitted by the satellite antenna aperture; and
control gain of at least one amplifier circuit stage of the upconverter circuit based on the measured gain of the satellite antenna aperture.

9. The aircraft satellite communication terminal of claim 7, wherein the power controller is further configured to:
receive power measurement feedback through a communication link with a satellite, wherein the power measurement feedback indicates a power measurement of the satellite carrier frequency signaling received by a receiver of the satellite;
measure gain of the satellite antenna aperture based on power measurement by a fourth power measurement circuit of the satellite carrier frequency signaling received through the input interface of the satellite antenna aperture and based on the power measurement feedback; and
control gain of at least one amplifier circuit stage of the upconverter circuit based on the measured gain of the satellite antenna aperture.

10. The aircraft satellite communication terminal of claim 1, wherein the power controller is configured to:
adapt values stored in a gain table based on the power measurements by the at least two power measurement circuits; and
control power level of the intermediate frequency signaling provided to the output interface of the modem, responsive to the adapted values stored in the gain table.

11. The aircraft satellite communication terminal of claim 10, wherein the power controller is further configured to:
perform the adapting of values stored in a gain table only when the values of corresponding ones of power measurements by the at least two power measurement circuits are within a threshold range of the values stored in the gain table.

12. The aircraft satellite communication terminal of claim 1, wherein the power controller is configured to:
adapt values stored in an offset table based on the power measurements by the at least two power measurement circuits; and
control power level of the intermediate frequency signaling provided to the output interface of the modem, responsive to the adapted values stored in the offset table combined with values stored in a gain table.

13. The aircraft satellite communication terminal of claim 1, wherein the power controller is configured to:
determine whether the power measurements by the at least two power measurement circuits satisfy a stable measurement rule; and
based on when the power measurements by the at least two power measurement circuits are determined to satisfy the stable measurement rule, switch from controlling power level of the intermediate frequency signaling provided to the output interface of the modem responsive to values stored in a gain table to controlling power level of the intermediate frequency signaling provided to the output interface of the modem responsive to the power measurements by the at least two power measurement circuits.

14. The aircraft satellite communication terminal of claim 13, wherein the power controller is further configured to determine whether the power measurements by the at least two power measurement circuits satisfy the stable measurement rule, based on operations to:
determine whether the power measurements by the at least two power measurement circuits satisfy corresponding power threshold values.

15. The aircraft satellite communication terminal of claim 1, wherein the operation by the power controller to control power of the intermediate frequency signaling provided through the output interface of the modem and/or to control power of the satellite carrier frequency signaling provided through the output interface of the upconverter circuit, based on the power measurements by the at least two power measurement circuits, comprises to:
initiate use of the power measurements by the at least two power measurement circuits to control power of the intermediate frequency signaling, based on determining that data traffic contained in presently received data packets from the aircraft on-board network will cause the upconverter circuit to generate the satellite carrier frequency signaling provided through the output interface with at least a threshold duration.

16. The aircraft satellite communication terminal of claim 15, wherein the operation by the power controller to control power of the intermediate frequency signaling provided through the output interface of the modem and/or to control power of the satellite carrier frequency signaling provided through the output interface of the upconverter circuit, based on the power measurements by the at least two power measurement circuits, further comprises to:
cease use of the power measurements by the at least two power measurement circuits to control power of the intermediate frequency signaling, based on determining that data traffic contained in later received data packets from the aircraft on-board network will cause the upconverter circuit to generate the satellite carrier frequency signaling provided through the output interface with less than the threshold duration.
